(19) United States
(12) Patent Application Publication
(10) Pub. No.: US 2026/0119290 A1
(43) Pub. Date: Apr. 30, 2026

(54) SYSTEMS AND METHODS FOR INTEGRATIONS ON DEMAND

(71) Applicant: ServiceNow, Inc., Santa Clara, CA (US)

(72) Inventors: Akhilesh Kondra, Fremont, CA (US); Michael Brian Meiner, Highland Park, NJ (US); Venkatram Reddy Miriyala, Hyderabad (IN); Ameya Sudhir Naik, Mumbai (IN); Anup Keerthan Ruban, Palamaner (IN)

(21) Appl. No.: 18/933,420

(22) Filed: Oct. 31, 2024

(51) Int. Cl. G06F 9/54

(52) U.S. Cl. CPC G06F 9/547

(57) ABSTRACT

A method includes receiving, from a client device, a request, wherein satisfying the request includes interaction with a third-party software product, identifying, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product, transmitting, via an application programming interface (API), a call to the third-party software product to perform the action, receiving, via the API, a response to the call from the third-party software product, and transmitting, to the client device, a reply to the request, wherein the reply to the request includes a piece of information from the response to the call.

### TECHNICAL FIELD

The present disclosure relates generally to interacting with third-party software products, and more specifically to creating integrations with third-party software products on-demand.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In cloud-based architectures, a virtual agent may utilize integrations to interact with (e.g., retrieve data from or send data to) third-party software products (e.g., enterprise resource planning software, human resources software, benefits management software, procurement software, information technology (IT) security software, accounting software) by using pre-developed automations to execute a sequence of actions. However, developing automations is resource intensive (e.g., developing a single automation may take days or weeks). Further, it may be an inefficient use of resources to develop automations for every conceivable scenario that may arise. Accordingly, when a virtual agent receives a request for which a pre-developed automation does not exist, the virtual agent may not be able to fulfill the request. New techniques are needed for enabling virtual agents to satisfy requests that do not have corresponding pre-developed automations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving, from a client device, a request, wherein satisfying the request includes interaction with a third-party software product, identifying, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product, transmitting, via an application programming interface (API), a call to the third-party software product to perform the action, receiving, via the API, a response to the call from the third-party software product, and transmitting, to the client device, a reply to the request, wherein the reply to the request includes a piece of information from the response to the call.

In another embodiment, a system includes processing circuitry and a memory, accessible by the processing circuitry, and storing instructions that, when executed by the processing circuitry, cause the processing circuitry to execute a client instance, wherein the client instance is configured to receive, from a client device, a request, wherein satisfying the request includes interaction with a third-party software product, identify, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product, transmit, via an application programming interface (API), a call to the third-party software product to perform the action, receive, via the API, a response to the call from the third-party software product, and transmit, to the client device, a reply to the request, wherein the reply to the request includes a piece of information from the response to the call.

In a further embodiment, a non-transitory, computer readable medium includes instructions that, when executed by processing circuitry, cause the processing circuitry to receive, from a client device, a request, wherein satisfying the request includes interaction with a third-party software product, identify, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product, transmit, via an application programming interface (API), a call to the third-party software product to perform the action, receive, via the API, a response to the call from the third-party software product, and transmit, to the client device, a reply to the request, wherein the reply to the request includes a piece of information from the response to the call.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that enables a client instance and hosts an integration hub and a virtual agent, in accordance with aspects of the present disclosure;

FIG. 5 is a schematic of the integration hub of FIG. 4 and the virtual agent, in accordance with aspects of the present disclosure;

FIG. 6 is a schematic of an architecture for providing integrations on demand via the virtual agent and the integration hub of FIGS. 4 and 5, in accordance with aspects of the present disclosure;

FIG. 7 is a screenshot of a home screen, accessible via a client device, from which a chat conversation can be launched and conducted in a chat window to provide integrations on demand, in accordance with aspects of the present disclosure;

FIG. 8 is a remainder of the chat conversation initiated in FIG. 7, in accordance with aspects of the present disclosure; and

FIG. 9 is a flow chart of a process for providing integrations on demand, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A virtual agent may utilize integrations to interact with (e.g., retrieve data from or send data to) third-party software products (e.g., enterprise resource planning software, human resources software, benefits management software, procurement software, information technology (IT) security software, accounting software) by using pre-developed automations to execute a sequence of actions. However, developing automations is resource intensive (e.g., developing a single automation may take days or weeks). Further, it may be an inefficient use of resources to develop automations for every conceivable scenario that may arise. Accordingly, when a virtual agent receives a request for which a pre-developed automation does not exist, the virtual agent may not be able to fulfill the request. New techniques are needed for enabling virtual agents to satisfy requests that do not have corresponding pre-developed automations.

Various embodiments disclosed herein are directed to techniques for generating integrations with third-party software products on demand. A system receives a request from a client device. The system may determine that satisfying the request involves interaction with a third-party software product (e.g., data utilized to fulfill the request is stored at the third party). The system may provide the request as an input to a large language model (LLM). In some embodiments, the system input includes contextual information provided by the system. Contextual information may include, for example, relevant knowledge graphs (e.g., representations of information about objects and relationships between objects, visualized as a network where nodes represent respective objects and edges represent the connections between objects), information about the third-party software product, identification of one or more spokes (e.g., a grouping of flows, subflows, actions, and supporting files that enable interaction with a third-party software product) associated with the third-party software product, identification of one or more application programming interfaces (APIs) associated with the third-party software product, identification of available actions, information about the requesting profile, and so forth. The LLM generates an output identifying a sequence of actions to be executed via a spoke associated with the third-party software product. The system auto-populates a call to the third-party software product based on available information (e.g., requestor profile data, the request, known information about the third-party software product, etc.) and provides the auto-populated call to the client device for review. Upon receiving approval of the call, the system makes the call to the third-party software product via an API associated with the third-party software product. The system receives a response from the third-party software product, identifies relevant information in the response based on the request, modifies the response to remove irrelevant data and put the response in a more conversational tone, and provides the modified response to the client device. In some embodiments, the request may be fulfilled by a single call to the third-party software product. In other embodiments, fulfillment of the request may involve multiple calls to the third-party software product, calls to other third-party software products, calls to internal systems, and so forth. Accordingly, the system may perform additional actions to fulfill the request.

Use of the disclosed techniques drastically expands the capabilities of virtual agents without the specific capabilities having to be specifically developed, resulting in more efficient use of resources in virtual agent development. Further, virtual agents utilizing the disclosed techniques may perform tasks using fewer resources and with less intervention from human agents.

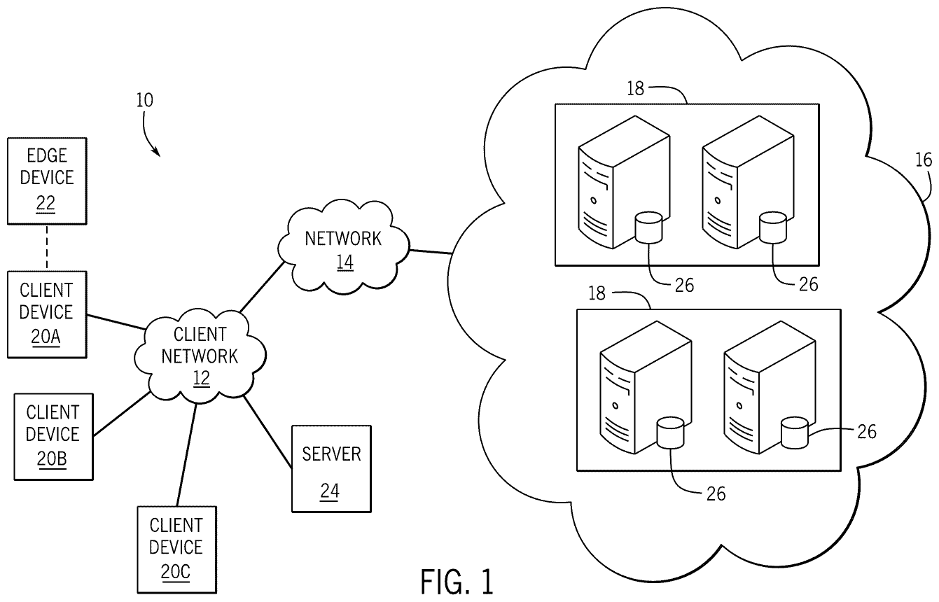

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

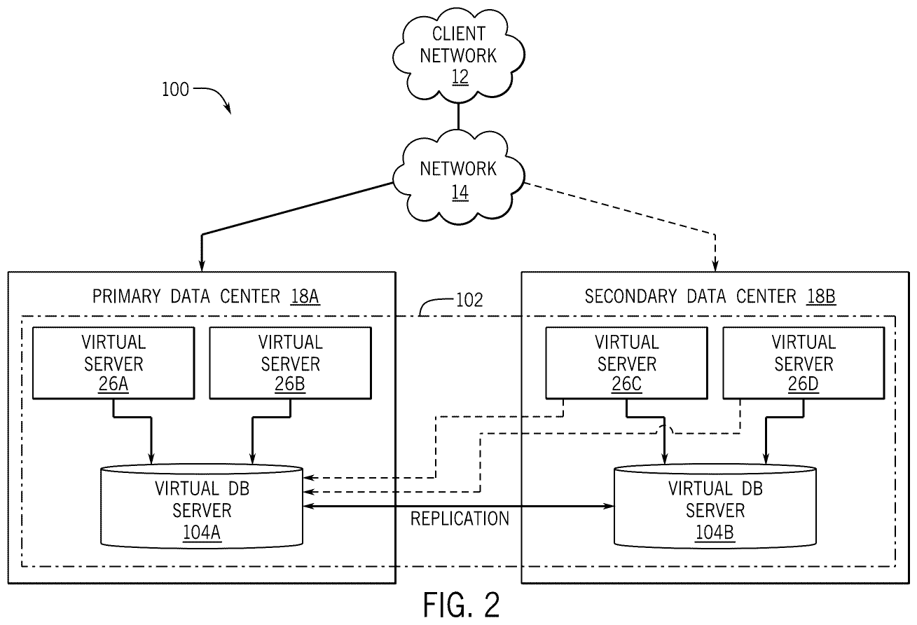

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

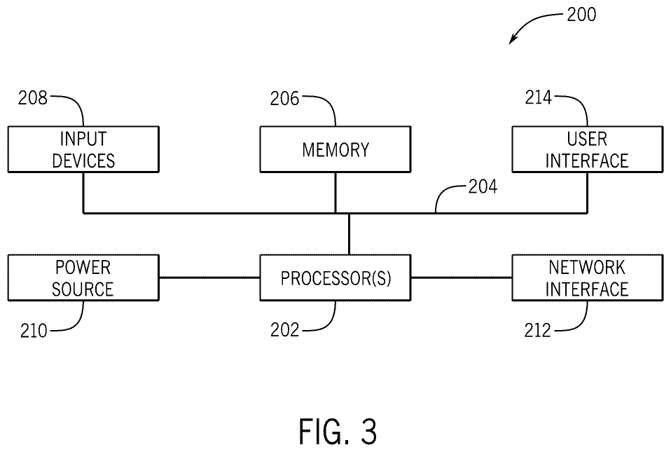

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

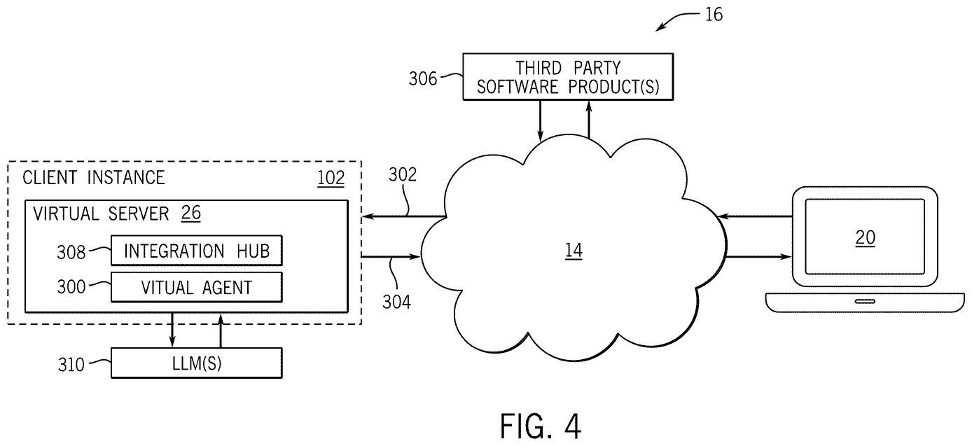

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices.

As mentioned above, an end-user may also interface with the client instance 102 using an application and/or a web browser of the client device 20. For example, the end user may use the client device 20 to interface with a virtual agent 300 hosted by the virtual server 26. Specifically, the client device may provide inputs 302 to the virtual agent 300, which may include requests that the virtual agent 300 perform various tasks, such as retrieving information, updating stored information, storing information, ordering items, requesting permissions, scheduling travel, and so forth. The virtual agent 300 may respond to the inputs 302 with outputs 304 transmitted back to the client device 20. The outputs may include, for example, retrieved data, confirmation of tasks to be performed, confirmation that tasks were performed, requests for additional information, and so forth. Accordingly, the client device 20 may carry out a conversation with the virtual agent 300 over a series of inputs 302 and outputs 304. Satisfying the requests may involve the virtual agent 300 interfacing with one or more third-party software products 306 (e.g., via an application programming interface (API)). For example, satisfying a request may involve retrieving data from and/or sending data to third-party software used for human resources, benefits management, payroll, accounting, procurement, time keeping, resource management, purchasing, and so forth. As will be described in more detail below, the virtual agent 300 may utilize an integration hub 308 and one or more large language models (LLMs) 310 to identify one or more defined actions that correspond to the request and carry out the identified actions via one or more spokes.

The LLMs 310 may be probabilistic models of a natural language used for general-purpose language generation. LLMs 310 typically include one or more artificial neural networks having a transformer-base architecture. LLMs 310 learn statistical relationships from text documents through training processes that may be supervised, semi-supervised, or self-supervised. During training, LLMs 310 may learn syntax, semantics, and/or ontology. LLMs 310, when used for text generation, receive an input text and iteratively predict the next word or token. It should be understood that the client instance 102 shown in FIG. 4 may be utilized by the client device 20 for other tasks, as well as tasks beyond the scope of integration generation and/or modification.

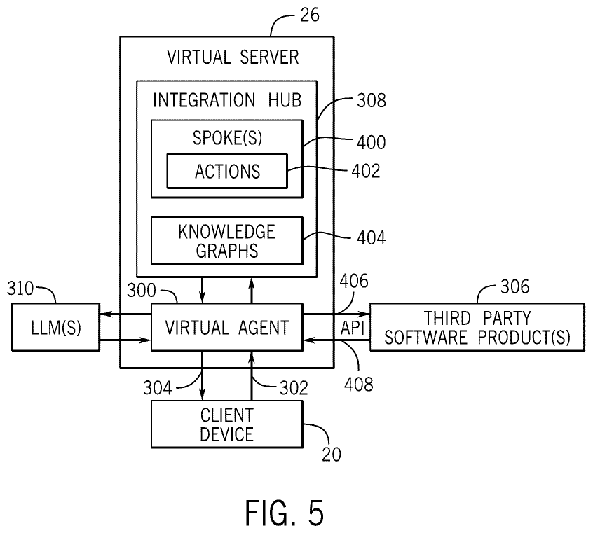

FIG. 5 is a schematic of the integration hub 308 of FIG. 4. As previously described, the virtual agent 300 receives the input 302 from the client device 20 that includes a request to interact with the third-party software product 306. The virtual agent 300 provides the input 302 as a prompt to one or more LLMs 310 for analysis. The virtual agent 300 may provide the input 302 to the LLMs 310 exactly as received from the client device 20, or may perform some processing or prompt engineering such that the prompt provided to the LLMs 310 results in a more useful output from the LLMs 310. The virtual agent 300 may also pass contextual information to the LLMs 310, or the LLMs 310 may have access to contextual information, such as available spokes 400, workflows, subflows, actions 402, knowledge graphs, etc. The LLMs 310 generate an output based on the prompt, and in some embodiments, the contextual information, identifying one or more spokes 400 and/or one or more actions 402 of the integration hub 308 for satisfying the request.

The virtual agent 300 interfaces with the integration hub 308 and uses the one or more spokes 400 and/or one or more actions 402 of the integration hub 308 that were identified by the LLMs 310 to interact with the third-party software product 306 via an API. Specifically, the virtual agent 300 generates an API call 406 to the third-party software product 306 to perform the identified action 402 based on the spoke 400. The virtual agent 300 receives an API response 408 from the third-party software product 306. In some embodiments, the virtual agent 300 engages in an iterative exchange with the third-party software product 306 in which multiple API calls 406 and responses 408 are exchanged. For example, if multiple actions 402 are identified by the LLMs 310, execution of the multiple actions by the virtual agent 300 may involve multiple API calls 406 and responses 408 with one or more third-party software products 306. The API calls 406 may include requests to retrieve data, requests to modify data records, requests to store data records, etc. Accordingly, the API responses 408 may include retrieved data, confirmation that records have been updated and/or stored, and so forth. In some embodiments, data from the API calls 406 and/or responses 408 may be stored locally (e.g., in memory) by the virtual agent 300. Further, in some embodiments, calls may also be made to internal systems (e.g., databases, tools, etc.).

The integration hub 308 may be defined herein as a software system that may provide for “codeless” development and integration with the aforementioned spokes 400. More specifically, the integration hub may include or operatively couple with a Flow Designer system that provides “codeless” development of software via natural language and visual information presentation. “Codeless” development may be defined herein as software development where the creator of the software does not use a computer language., e.g., Java, Javascript, C#, and the like. Instead, the creator of the software may use natural language and visual tools to create the software, for example, by designing a flowchart-like process that may take certain inputs and executes certain actions. A spoke 400 may be a software system that is included as a subsystem of the integration hub 308. The integration hub 308 may utilize the various spokes 400 to define automated processes that facilitate communication between the third-party software product 306 and/or service providers (e.g., remote software applications and/or services offered by the third-party provider) and the enterprise hosting the integration hub 308 (e.g., without having to create code via traditional computer languages). For example, the integration hub 308 may enable actions 402 to be defined that interact with and utilize objects and/or functions provided by one or more third-party software products 306 (e.g., applications and/or services provided by a third-party provider). The third-party software products 306 may be developed and hosted by third-party computing systems different from a computing system (e.g., a remote network management platform) that may host the virtual agent 300 and/or execute a workflow (e.g., specific sequence or series of tasks that, when performed, accomplish one or more goals) that calls on the objects and/or functions of the one or more third-party software products 306. The automated processes may interact with third-party software product and/or service providers to provide enhanced functionality by accessing any number of services, such as web-based services, that may include weather forecasting services, financial services, information technology (IT) services, engineering services, time keeping services, human resources services, benefits management services, purchasing/procurement services, payroll services, asset management services, and the like. That is, the spokes 400 may be utilized to access the services provided by the third-party service providers in a more seamless and efficient manner relative to traditional computing systems.

The actions 402 within a spoke 400 may be used as building blocks to build workflows and/or subflows. Interaction between workflows and the third-party software products 306 may be facilitated by the spokes 400. In certain cases, the integration hub 308 may include or be operatively coupled to a wizard, which may be a setup assistant or user interface type that presents a user with a sequence of one or more dialog boxes that aid the user in accomplishing the setup of one or more spokes 400. The computing system that executes the actions 402, the spoke 400, and the computing systems that execute the third-party software products 306 may each be physically separate and distinct systems. The spoke 400 may serve as an intermediary between the computing system that executes the actions 402 and the computing systems that execute the third-party software products 306. Thus, the actions 402 may transmit, to the spoke 400, a request for execution of certain functions provided by the third-party software products 306. The spoke 400 may, in turn, request execution of these certain functions from the third-party software products 306. Output of the functions may similarly be provided by the third-party software products 306 to the actions 402 by way of the spoke 400.

Each API provider (e.g., third-party software product provider) may include documentation (e.g., a specification) that defines the attributes of the corresponding API. Namely, the specification may define the objects (e.g., services) accessible by way of the API, the functions invokable by way of the API, the inputs for these functions, and the outputs of these functions, among other possible attributes. Virtual agent 300 may leverage the power of the LLMs 310 to analyze, parse, and/or process various natural language inputs 302 and/or API responses 408 from the API providers.

For example, the specification may include data corresponding to actions 402 that enable interaction with objects and/or functions of a particular third-party software product 306. The actions 402 may collectively define an interface for the particular third-party software product 306, which may alternatively be referred to as the spoke 400. For example, each action 402 of a spoke 400 may be configured to receive input values for a function of the third-party software product 306, generate and transmit an API call 406 that includes therein the input values, receive an API response 408 from the provider, identify output values of the function in the response, and expose the output values to other actions via output variables. Thus, upon receiving the specification, the integration hub 308 may parse through the specification and analyze the specification to generate the list of actions 402 that interact with the objects and/or functions (e.g., services) provided by the third-party software product 306.

The spokes 400 may be configured to facilitate communication of data between the virtual agent 300 (e.g., hosted by the client instance 102 of FIG. 4) and the third-party software products 306. The data may be a file, database table(s), or set of associations that includes account information details (e.g., passwords, usernames) and access details for computing services offered by the third-party software products 306. For instance, given that a particular computing service may be accessed through an integration point, such as an API endpoint, data may contain a list of API endpoints for computing services. In examples, these API endpoints may include representational state transfer (REST) APIs, Simple Object Access Protocol (SOAP) APIs, GraphQL APIs, or other types of API architectures. Additionally, the data may include one or more mappings between descriptions of the computing services offered by the third-party software products 306 and configuration items stored in a database.

Thus, the data may correspond to one or more actions 402 that enable interaction with one or more objects and/or functions of a particular third-party software product 306 (e.g., list of API endpoints, list of integration points, mappings, and the like). For example, each action 402 of a spoke 400 may be configured to receive input values for a function of the third-party software product 306, generate and transmit an API call 406 to the third-party software product 306 that includes the input values, receive an API response 408 from the third-party software product 306, identify output values of the function in the response 408, and expose the output values to other actions via output variables. The virtual agent 300 may then process the API response 408 and generate and transmit an output 304 to the client device 20 based on the API response 408.

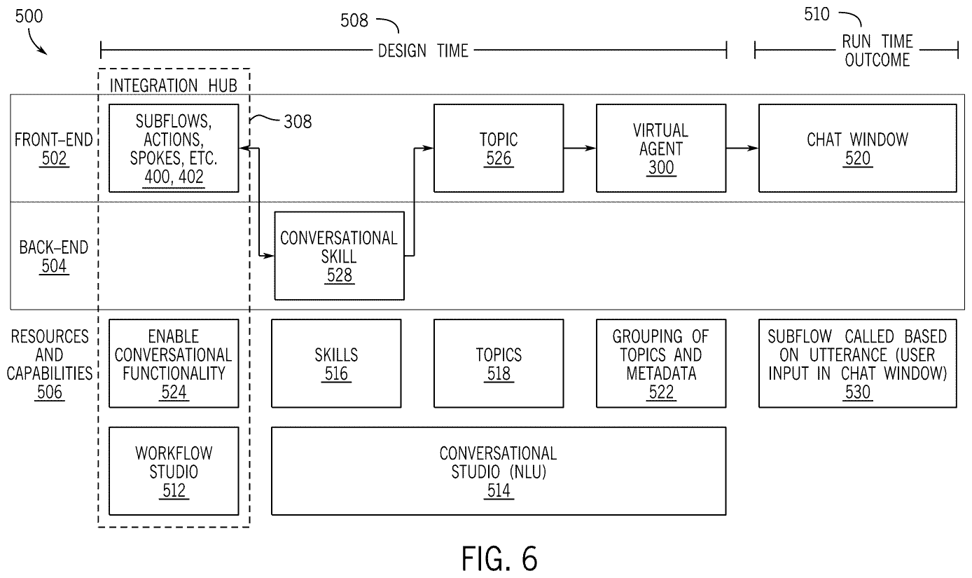

FIG. 6 is a schematic of an architecture 500 for providing integrations on demand via the virtual agent and the integration hub of FIGS. 4 and 5. As shown, the architecture includes components on a front end 502, which may run on a client device (e.g., the client devices 20 shown in FIGS. 1, 4, and 5) or a client instance (e.g., client instance 102 shown in FIGS. 2 and 4) hosted by a virtual server (e.g., the virtual server 26 shown in FIGS. 1, 2, 4, and 5) and a back end 504, which may run on a physical server or a virtual server (e.g., such as the servers 24 and 26 shown in FIGS. 1, 2, 4, and 5). The architecture 500 also includes a collection of resources and capabilities 506, which may be instantiated as applications, scripts, or portions of code hosted on the front end 502, the back end 504, or some other accessible resource. It should be understood, however, that the architecture 500 shown in FIG. 6 is merely one embodiment and that other embodiments are envisaged in which one or more components shown in FIG. 6 as being hosted on the front end 502 may be hosted on the back end 504. Similarly, embodiments are envisaged in which one or more components shown in FIG. 6 as being hosted on the back end 504 may be hosted on the front end 502.

Further, as shown, the various components of the architecture 500 are shown in FIG. 6 as sorted into design time 508 and run time 510. Design time 508 generally refers to the phase in which a component, program, or capability is being built and designed (e.g., defining structure, properties, appearance, etc.) in a development environment. Run time 510 generally refers to the phase when the component, program, or capability is actively running and executing code on a client device, such as processing data and performing its intended functions.

As shown and previously described, the integration hub 308 may store a collection of actions 402 that may be used by the virtual agent to perform various tasks. Subflows may combine various actions 402 in sequence to perform one or more tasks. Flows may then combine subflows and/or actions to perform one or more tasks. The spokes 400 may include groupings of flows, subflows, actions, and supporting files that enable interaction with a third-party software product. The flows, subflows, spokes 400, and actions 402 may be designed via a workflow studio 512, which is a tool for defining various characteristics of one or more flows, subflows, spokes 400, or actions 402. The workflow studio 512 may include a no-code style visual programming interface for arranging components and defining various parameters and/or characteristics. In other embodiments, the workflow studio 512 may include code editor for writing and editing code that defines various parameters and/or characteristics of flows, subflows, spokes 400, and/or actions 402. Similarly, a conversational studio 514 is a tool for defining the various conversational or natural language understanding (NLU) aspects of the virtual agent. Accordingly, the conversational studio 514 may be used to define skills, topics, and so forth such that the virtual agent 300 can converse with a user of a client device in a chat window 520. Each of the skills 516 includes a data model and/or data architecture that is used by the virtual agent 300 in conversation, but is not surfaced in the user interface (e.g., chat window 520). Each of the topics 518 includes one or more skills of the skills 516 along with a package of metadata. Topics may then be further grouped into groupings 522 of topics 518 and associated metadata.

The conversational functionality 524 enables the virtual agent 300 to interact with the integration hub 308 using the conversational capabilities programmed via the conversational studio 514. For example, the conversational functionality 524 may include the virtual agent 300 being able to initiate flows and/or subflows, perform actions, utilize spokes, link actions together to perform various tasks and generate integrations with third-party software products on demand, retrieve data, modify data, provide data, and so forth.

Accordingly, the virtual agent 300 may receive an utterance via a chat window 520 displayed on a client device. The utterance may include, for example, a request to perform some task that may involve a third-party software product (e.g., replacing a lost phone, asking how many vacation days the user has left this year, requesting help with a computer issue, etc.). The virtual agent 300 may select a particular topic 526 from the available topics 518 that the virtual agent identifies as related to the utterance. The virtual agent utilizes one or more conversational skills 528 associated with the topic 526 to identify one or more spokes 400, actions 402, subflows or flows that can be used by the virtual agent 300 to perform the requested task. In some embodiments, the virtual agent may utilize an LLM to identify relevant spokes and/or actions.

If a subflow already exists, the virtual agent can call the particular subflow 530 based on the utterance to perform the task. If a subflow for performing the requested task does not exist, the virtual agent 300 and/or an LLM may use knowledge graphs or other related information to identify a sequence of actions 402 that can be performed to complete the task, basically creating a new subflow to perform the task on the fly. If the task is relatively simple and/or straight forward, the virtual agent 300 may be able to perform the requested task based solely on the initial utterance provided in the chat window 520. However, in other embodiments, the virtual agent 300 may provide responses to the utterance in the chat window 520 requesting additional information. For example, if one or more of the actions utilize information that is not available to the virtual agent 300, the virtual agent 300 may ask the user for the information in the chat window 520. Further, the virtual agent 300 may interact with the user via the chat window 520 to confirm information and/or to confirm that the user wishes for the virtual agent 300 to perform certain actions.

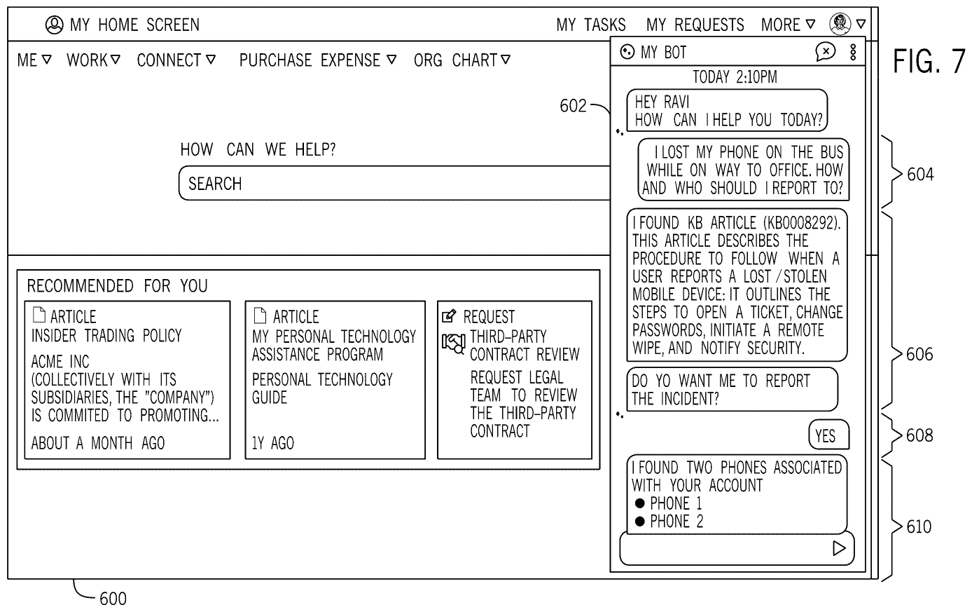

FIG. 7 is a screenshot of a home screen 600, accessible via a client device (e.g., the client device 20 of FIGS. 1, 4, and 5), from which a chat conversation can be launched and conducted in a chat window 602 to provide integrations on demand. At 604, the user provides an utterance indicating that he lost his phone and asking how to report the lost phone. In response to receiving the utterance, the virtual agent may identify (e.g., using an LLM) one or more spokes associated with responding to a lost phone, and may identify one or more actions that may be performed after a phone has been lost. At 606, the virtual agent responds that it has identified a knowledge base (KB) article that describes a procedure to follow when a phone has been lost, provides a link to the KB article, summarizes the KB article and asks the user if he would like the virtual agent to report the lost phone. At 608, the user indicates that he would like for the virtual agent to report the lost phone. The virtual agent identifies (e.g., via an LLM) a sequence of actions to be performed, using the procedure outlined in the KB article as a reference (e.g., contextual information). The virtual agent identifies two phones associated with the user's profile and, at 610, provides an indication of the two phones.

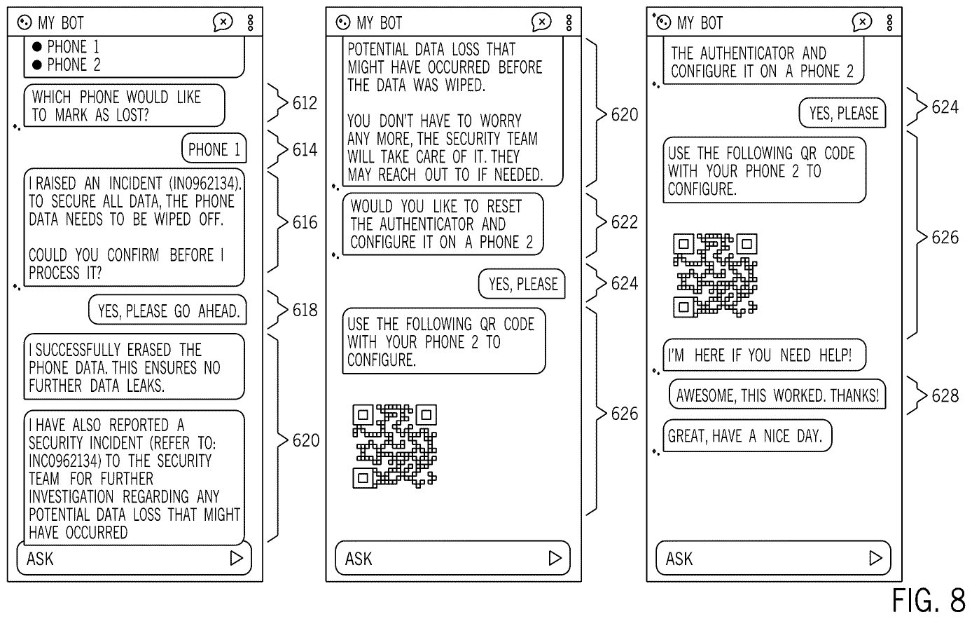

FIG. 8 is a remainder of the chat conversation initiated in FIG. 7, in accordance with aspects of the present disclosure. At 612, the virtual agent asks which of the two identified phones the user wishes to report as lost. At 614, the user identifies Phone 1 as the lost phone. At 616, the virtual agent indicates that it has generated an incident (e.g., performed an action), provides an incident number and a link to the incident. The virtual agent also informs the user that to secure the data on the phone, the data needs to be erased from the phone. The virtual agent asks for confirmation before initiating the action to remotely erase the data from the phone. At 618, the user confirms. The virtual agent proceeds to perform one or more actions to remotely erase data from the lost phone and generate a security incident for investigation into possible data loss from the device. At 620, the virtual agent responds to inform the user that data has been successfully erased from the lost phone and that a security incident has been reported to the security team for investigation into data loss from the lost phone before the data was erased. The virtual agent further reassures the user not to worry about the lost phone and informs the user that the security team may contact the user if more information about the lost phone is needed.

At 622, the virtual agent asks the user if the user wishes to reset his authentication application and configure the authentication application on his other phone (e.g., Phone 2). At 624, the user indicates that he would like to reset the authentication application and reconfigure it on his other phone. The virtual agent initiates one or more actions to reset the authentication application and reconfigure it for the user's other phone, which involves generating a quick response (QR) code for the user to scan to perform the reset and reconfiguration of the authentication application on the user's other phone. At 626, the virtual agent provides the QR code to the user for the user to scan to reset and reconfigure the authentication application on his other phone. At 628, the user confirms that he was able to successfully reset and reconfigure the authentication application on his other phone.

It should be understood, however, that the conversation shown in FIGS. 7 and 8 regarding reporting a lost phone is merely an example of a task that could be performed using the disclosed techniques and that the disclosed techniques may be used to perform any number of tasks that may involve use of a third-party software application. Accordingly, the present disclosure is not intended to be limited to the example embodiment shown in FIGS. 7 and 8. As such, embodiments are envisaged in which the disclosed techniques are used to perform a wide range of other tasks.

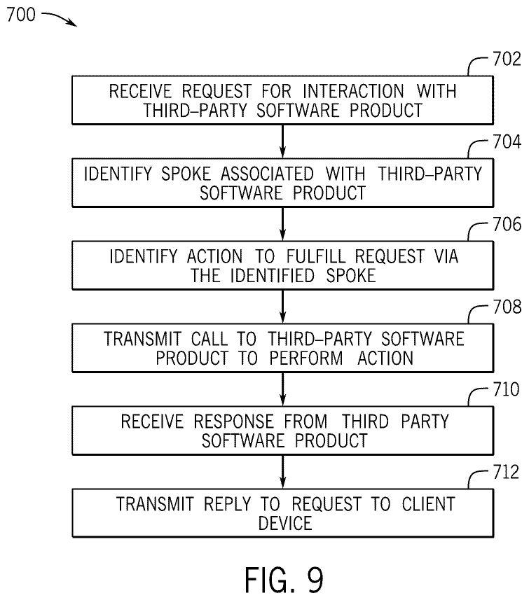

FIG. 9 is a flow chart of a process 700 for providing integrations on demand. At 702, the process 700 receives a request for interaction with a third-party software product. As previously described, the interaction with the third-party software product may include or be a part of performance of a task. The interaction may include, for example, retrieving data, modifying stored data (e.g., updating a data record), providing data to be stored, and so forth. The third-party software product may include, for example, enterprise resource planning software, human resources software, benefits management software, procurement software, information technology (IT) security software, accounting software, and so forth. The request may be received via a message in a chat window, an email, an input provided in a window of a webpage or application, and so forth.

At 704, the process 700 identifies a spoke associated with the third-party software product. A spoke is a grouping of flows, subflows, actions, and supporting files that enable interaction with the third-party software product. Accordingly, an enterprise may define respective spokes for third-party software products, platforms, and services the enterprise uses for various functions. In some embodiments, an enterprise may utilize a single spoke for interaction with multiple third-party software products, and/or may utilize multiple spokes for different aspects of a single third-party software product (e.g., one spoke for accounting functionality of a third-party software product and another spoke for benefits management of the same third-party software product). Accordingly, the process 700 may provide the request as an input to a large language model (LLM), which may identify the appropriate spoke based on the third-party software product associated with the request and one or more tasks to perform to satisfy the request. In some embodiments, the LLM may further be provided with contextual information, such as relevant knowledge graphs (e.g., representations of information about objects and relationships between objects, visualized as a network where nodes represent respective objects and edges represent the connections between objects), information about the third-party software product, identification of one or more spokes (e.g., a grouping of flows, subflows, actions, and supporting files that enable interaction with a third-party software product) associated with the third-party software product, identification of one or more application programming interfaces (APIs) associated with the third-party software product, identification of available actions, information about the requesting profile, and so forth. The LLM may then generate an output identifying the relevant spoke. For complex tasks that may involve multiple third-party software products, the process 700 may identify multiple spokes.

At 706, the process 700 identifies one or more actions from the available actions associated with the identified spoke to fulfill the request. For example, based on the request provided to the LLM, and in some embodiments the contextual information, the LLM may further be configured to identify one or more actions from the actions associated with the identifies spoke, that may be performed to satisfy the request. In some embodiments, the spoke and the action are identified by the LLM in distinct steps, whereas in other embodiments, the LLM may revive the request and the contextual data as an input and generate an output that identifies the spoke and one or more actions to be performed to satisfy the request. Further, in some embodiments, the LLM may be used for one of blocks 704 and 706, but not the other (e.g., the LLM may be used to identify a spoke, but not one or more actions, or the LLM may be used to identify the one or more actions based on the request, contextual information, and a spoke identifies by some other resource, such as an algorithm). Using an LLM to identify one or more actions from a library of available actions associated with a spoke, and then link together a sequence of actions that did not previously exist as a flow or subflow drastically expands the capabilities of virtual agents without the specific capabilities having to be specifically developed. Accordingly, the process 700 enables a virtual agent to generate integrations with third-party software product on demand without being limited to existing flows and subflows. Such techniques enable virtual agents to perform tasks utilizing fewer computing resources and with less human intervention and unlock more efficient use of resources in virtual agent development.

At 708, the process 700 generates a call (e.g., an API call) to the third-party software product to perform the identified action and transmits the call to the third-party software product via an API. As previously described, the call may be to retrieve data, to modify stored data, or to store new data. At 710, the process 700 receives a response from the third-party software product via the API. If the call was to retrieve data, the response may include the retrieved data. If the call was to modify stored data or store new data, the response may include a confirmation that the stored data has been modified or that the new data has been stored.

At 712 a reply to the request is transmitted to the client device. If the request is to retrieve data, the reply may include the retrieved data. If the request was to modify existing data or to store new data, the reply may include confirmation that the data has been modified or that the data has been stored. If the process 700 needs more information from the user to perform the actions, the reply may include a request for additional information or confirmation to perform the identified actions. Upon receipt of the additional information or the confirmation, the process 700 may return to block 708 and transmit a call to the third-party software product to perform the action. If multiple actions are identified, the process 700 may return to block 708 and generate a call to the third-party software product to perform the subsequent action.

In some embodiments, a chat session or other interaction with a user may involve multiple requests. Accordingly, after a reply is transmitted to the client device at 712, an additional request may be received and the process may return to block 702. In such cases, not every exchange of a request and a reply between the user and the virtual agent may involve identifying spokes/actions and transmitting a call to the third-party software product. Accordingly, some executions of the process 700 may omit one or more of the blocks shown in FIG. 9 and/or may add additional steps not shown in FIG. 9.

The presently disclosed techniques are directed to techniques for generating integrations with third-party software products on demand. A system receives a request from a client device. The system may determine that satisfying the request involves interaction with a third-party software product (e.g., data utilized to fulfill the request is stored at the third-party). The system may provide the request as an input to a large language model (LLM). In some embodiments, the system input includes contextual information provided by the system. Contextual information may include, for example, relevant knowledge graphs (e.g., representations of information about objects and relationships between objects, visualized as a network where nodes represent respective objects and edges represent the connections between objects), information about the third-party software product, identification of one or more spokes (e.g., a grouping of flows, subflows, actions, and supporting files that enable interaction with a third-party software product) associated with the third-party software product, identification of one or more application programming interfaces (APIs) associated with the third-party software product, identification of available actions, information about the requesting profile, and so forth. The LLM generates an output identifying a sequence of actions to be executed via a spoke associated with the third-party software product. The system auto-populates a call to the third-party software product based on available information (e.g., requestor profile data, the request, known information about the third-party software product, etc.) and provides the auto-populated call to the client device for review. Upon receiving approval of the call, the system makes the call to the third-party software product via an API associated with the third-party software product. The system receives a response from the third-party software product, identifies relevant information in the response based on the request, modifies the response to remove irrelevant data and put the response in a more conversational tone, and provides the modified response to the client device. In some embodiments, the request may be fulfilled by a single call to the third-party software product. In other embodiments, fulfillment of the request may involve multiple calls to the third-party software product, calls to other third-party software products, calls to internal systems, and so forth. Accordingly, the system may perform additional actions to fulfill the request.

Use of the disclosed techniques drastically expands the capabilities of virtual agents without the specific capabilities having to be specifically developed, resulting in more efficient use of resources in virtual agent development. Further, virtual agents utilizing the disclosed techniques may perform tasks using fewer resources and with less intervention from human agents.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving, from a client device, a request, wherein satisfying the request includes interaction with a third-party software product;
identifying, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product;
transmitting, via an application programming interface (API), a call to the third-party software product to perform the action;
receiving, via the API, a response to the call from the third-party software product; and
transmitting, to the client device, a reply to the request, wherein the reply to the request includes a piece of information from the response to the call.

2. The method of claim 1, comprising:
receiving, from the client device, an additional request in response to the reply;
transmitting, via the API, an additional call to the third-party software product to perform an additional action;
receiving, via the API, an additional response to the additional call from the third-party software product; and
transmitting, to the client device, an additional reply to the additional request, wherein the additional reply to the additional request includes an additional piece of information from the additional response to the additional call.

3. The method of claim 1, wherein satisfying the request includes interaction with the third-party software product and an additional third-party software product, the method further comprising:
identifying, via the LLM, an additional spoke associated with the additional third-party software product and an additional action to fulfill the request via the additional spoke;
transmitting, via an additional API, an additional call to the additional third-party software product to perform an additional action;
receiving, via the additional API, an additional response to the additional call from the additional third-party software product; and
transmitting, to the client device, an additional reply to the request, wherein the additional reply to the request includes an additional piece of information from the additional response to the additional call.

4. The method of claim 1, comprising:
generating the call based on contextual information;
transmitting, to the client device, the call for review; and
receiving, from the client device, an approval of the call.

5. The method of claim 1, comprising:
providing, to the LLM, contextual data comprising identification of a plurality of available spokes, including the spoke, a plurality of available actions, including the action, information about the third-party software product, information about the client device, information about a profile associated with the client device, a plurality of knowledge graphs, or any combination thereof.

6. The method of claim 1, wherein the identifying, via the LLM, the spoke associated with the third-party software product and the action to fulfil the request via the spoke, is based on a knowledge graph, wherein the knowledge graph comprises a representation of information about a plurality of objects and one or more relationships between the plurality of objects comprising a plurality of nodes and one or more edges, wherein each node of the plurality of nodes represents a respective object of the plurality of objects and wherein each edge of the one or more edges represents a respective relationship between two objects of the plurality of objects.

7. The method of claim 1, wherein the action comprises retrieving a record from the third-party software product.

8. The method of claim 1, wherein the action comprises updating a record stored by the third-party software product.

9. The method of claim 1, wherein the action comprises updating a record stored in a database.

10. The method of claim 1, wherein the client device is configured to display the reply to the request in a chat interface.

11. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving, from a client device, a request, wherein satisfying the request includes interaction with a third-party software product;
identifying, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product;
transmitting, via an application programming interface (API), a call to the third-party software product to perform the action;
receiving, via the API, a response to the call from the third-party software product; and
transmitting, to the client device, a reply to the request, wherein the reply to the request includes a piece of information from the response to the call.

12. The system of claim 11, wherein the operations comprise:
receiving, from the client device, an additional request in response to the reply;
transmitting, via the API, an additional call to the third-party software product to perform an additional action;
receiving, via the API, an additional response to the additional call from the third-party software product; and
transmitting, to the client device, an additional reply to the additional request, wherein the additional reply to the additional request includes an additional piece of information from the additional response to the additional call.

13. The system of claim 11, wherein satisfying the request includes interaction with the third-party software product and an additional third-party software product, wherein the operations comprise:
identifying, via the LLM, an additional spoke associated with the additional third-party software product and an additional action to fulfill the request via the additional spoke;
transmitting, via an additional API, an additional call to the additional third-party software product to perform an additional action;
receiving, via the additional API, an additional response to the additional call from the additional third-party software product; and
transmitting, to the client device, an additional reply to the request, wherein the additional reply to the request includes an additional piece of information from the additional response to the additional call.

14. The system of claim 11, wherein the operations comprise:
providing, to the LLM, contextual data comprising identification of a plurality of available spokes, including the spoke, a plurality of available actions, including the action, information about the third-party software product, information about the client device, information about a profile associated with the client device, a plurality of knowledge graphs, or any combination thereof.

15. The system of claim 11, wherein the identifying, via the LLM, the spoke associated with the third-party software product and the action to fulfil the request via the spoke, is based on a knowledge graph, wherein the knowledge graph comprises a representation of information about a plurality of objects and one or more relationships between the plurality of objects comprising a plurality of nodes and one or more edges, wherein each node of the plurality of nodes represents a respective object of the plurality of objects and wherein each edge of the one or more edges represents a respective relationship between two objects of the plurality of objects.

16. A non-transitory, computer readable medium comprising instructions that, when executed by processing circuitry, cause the processing circuitry to perform operations comprising:
receiving, from a client device, a request, wherein satisfying the request includes interaction with a third-party software product;
identifying, via a large language model (LLM), a spoke associated with the third-party software product and an action to fulfill the request via the spoke, wherein the spoke comprises one or more flows, one or more subflows, one or more actions, or a combination thereof, including the identified action, that enable interaction with the third-party software product;
transmitting, via an application programming interface (API), a call to the third-party software product to perform the action;
receiving, via the API, a response to the call from the third-party software product; and
transmitting, to the client device, a reply to the request, wherein the reply to the request includes a piece of information from the response to the call.

17. The non-transitory, computer readable medium of claim 16, wherein the operations comprise:
receiving, from the client device, an additional request in response to the reply;
transmitting, via the API, an additional call to the third-party software product to perform an additional action;
receiving, via the API, an additional response to the additional call from the third-party software product; and
transmitting, to the client device, an additional reply to the additional request, wherein the additional reply to the additional request includes an additional piece of information from the additional response to the additional call.

18. The non-transitory, computer readable medium of claim 16, wherein satisfying the request includes interaction with the third-party software product and an additional third-party software product, wherein the operations comprise:
identifying, via the LLM, an additional spoke associated with the additional third-party software product and an additional action to fulfill the request via the additional spoke;
transmitting, via an additional API, an additional call to the additional third-party software product to perform an additional action;
receiving, via the additional API, an additional response to the additional call from the additional third-party software product; and
transmitting, to the client device, an additional reply to the request, wherein the additional reply to the request includes an additional piece of information from the additional response to the additional call.

19. The non-transitory, computer readable medium of claim 16, wherein the operations comprise:
providing, to the LLM, contextual data comprising identification of a plurality of available spokes, including the spoke, a plurality of available actions, including the action, information about the third-party software product, information about the client device, information about a profile associated with the client device, a plurality of knowledge graphs, or any combination thereof.

20. The non-transitory, computer readable medium of claim 16, wherein the action comprises retrieving a first record from the third-party software product, updating a second record stored by the third-party software product, updating third record stored in a database, providing data for a new record to be stored, or any combination thereof.
